(19) United States
(12) Patent Application Publication
(10) Pub. No.: US 2006/0053943 A1
(43) Pub. Date: Mar. 16, 2006

(54) Rigidity tuning structure of transmission cable for manual transmission

(75) Inventors: Toyoaki Motonaga, Wako-shi (JP); Masaharu Ikawa, Wako-shi (JP); Junichi Emoto, Haga-gun (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/153,259

(22) Filed: Jun. 15, 2005

(30) Foreign Application Priority Data
Jun. 28, 2004 (JP) 2004-190111
Jun. 28, 2004 (JP) 2004-190112

(51) Int. Cl. F16C 1/10

(52) U.S. Cl. 74/502.4

(57) ABSTRACT

A transmission cable for transmitting operation of a transmission lever to a select arm or a shift arm is disposed in a curved state in a manual transmission. An inner cable protrudes from an outer tube of the transmission cable, whereby a set load in a compressing direction is generated in the inner cable. However, by ensuring that the rigidity of a rubber bush for connecting one end of the inner cable to the select arm or the shift arm is set so that it is lower in a direction of pushing the inner cable than in a direction of pulling the inner cable to provide an anisotropic property, the set load in the compressing direction in the inner cable can be countervailed by a difference in rigidity of the rubber bush between a pushing direction and a pulling direction to eliminate deterioration in shifting feeling.

### RELATED APPLICATION DATA

Japanese priority application Nos. 2004-190111 and 2004-190112, upon which the present application is based, are hereby incorporated in their entirety herein by reference.

### BACKGROUND OF THE INVENTION

1. Field of the Invention

The present invention relates to a rigidity tuning structure of a transmission cable for a manual transmission in which a transmission cable for transmitting operation of a transmission lever by a driver to a manual transmission comprises an outer tube and an inner cable slidably accommodated within the outer tube, the outer tube being fixed at one end to a casing of the manual transmission, and the inner cable being connected at one end to a select arm or a shift arm of the manual transmission through an elastic member.

The present invention also relates to a rigidity tuning structure of a transmission cable for a manual transmission in which a transmission cable for transmitting operation of a transmission lever by a driver to a manual transmission comprises an outer tube and an inner cable slidably accommodated within the outer tube, the inner cable being connected at one end to a select arm or a shift arm of the manual transmission, and the outer tube being supported at one end on a casing of the manual transmission with an elastic member interposed therebetween.

2. Description of the Related Art

Japanese Patent Application Laid-open No. 6-257668 discloses a rigidity tuning structure of a transmission cable, in which a spherical member is mounted at an intermediate portion of a transmission lever that is provided at its upper end with a knob adapted to be manipulated by a driver and that is connected at its lower end to the manual transmission through a transmission cable. A bearing for swingably supporting the spherical member is supported on a bracket through an inner metal cylinder, a rubber member having a void in a shifting direction and an outer metal cylinder, thereby reducing a difference between vibration received upon manipulation of the knob in the shifting direction and vibration received upon manipulation of the knob in a selecting direction to improve feeling in operation of the transmission lever.

A so-called Bowden cable comprising an outer tube and an inner cable slidably accommodated within the outer tube is used as the transmission cable for connecting the transmission lever and the manual transmission to each other. Such a transmission cable is often arranged in a state in which at least a part of the transmission cable is curved. Therefore, the following problem is encountered:

An upper part of FIG. 10 is a diagram showing a case where a transmission cable 03 comprising an outer tube 01 and an inner cable 02 is disposed rectilinearly, wherein the inner cable 02 protrudes by a length “a” from opposite ends of the outer tube 01, respectively. If the transmission cable 03 is curved as shown in a lower part of FIG. 10, the length of the inner cable 02 protruding from the outer tube 01 is a value “b” larger than the length “a” (b>a) . The reason is that a slight gap for enabling the sliding of the cable is provided between the outer tube 01 and the inner cable 02 (the gap is exaggeratingly represented in FIG. 10) and hence, when the transmission cable 03 is curved, the curvature of the inner cable 02 is smaller than the curvature of the outer tube 01, so that the inner cable 02 having the smaller curvature protrudes further from the outer tube 01 having the larger curvature.

However, this structure is designed such that a distance between a connection point of the outer tube 01 to a stationary member and a connection point of the inner cable 02 to a movable member is equal to the length “a” shown in the upper part of FIG. 10, and thus, if the distance is increased to the length “b”, a set load in a compressing direction is generated in the inner cable 02. As a result, when the inner cable 02 is operated in a pushing direction, a larger pushing force is required to overcome such a set load in the compressing direction, resulting in a hard operational feeling, and when the inner cable 02 is operated in a pulling direction, only a smaller pulling force is required because the inner cable 02 is urged by the set load in the compressing direction, resulting in a soft operational feeling.

If this is observed from another viewpoint, when a set load in the compressing direction is generated in the inner cable 02, a resulting reaction force causes a set load in the pulling direction to act on the outer tube 01, and thus, when the inner cable 02 is operated in the pushing direction, a larger pushing force is required to overcome a load compressing the outer tube 01, resulting in a hard operational feeling, and when the inner cable 02 is operated in the pulling direction, only a smaller pulling force is required because the inner cable 02 is urged by the load compressing the outer tube 01, resulting in a soft operational feeling.

Therefore, there is a problem that the shifting feeling is hardened, for example, when the inner cable 02 is pushed to establish a third gear shift stage, and the shifting feeling is softened, for example, when the inner cable 02 is pulled to establish a fourth gear shift stage.

### SUMMARY OF THE INVENTION

Accordingly, it is an object of the present invention to eliminate deterioration in speed shift feeling of a manual transmission due to a characteristic of a transmission cable.

In order to achieve the above-mentioned object, according to a first feature of the invention, there is provided a rigidity tuning structure of a transmission cable for a manual transmission in which a transmission cable for transmitting operation of a transmission lever by a driver to a manual transmission comprises an outer tube and an inner cable slidably accommodated within the outer tube, the outer tube being fixed at one end to a casing of the manual transmission, the inner cable being connected at one end to a select arm or a shift arm of the manual transmission through an elastic member, wherein rigidity of the elastic member differs between a pushing direction and a pulling direction of the inner cable.

A select cable 12 and a transmission cable 13 in a first embodiment disclosed herein correspond to the transmission cable of the present invention, and a rubber bush 36 in the first embodiment corresponds to the elastic member of the present invention.

With the above arrangement, even if a set load in a drawing direction or a compressing direction is applied to the inner cable due to the curvature of the transmission cable for transmitting the operation of the transmission lever to the select arm or the shift arm of the manual transmission, because the rigidity of the elastic member connecting one end of the outer tube to the select arm or the shift arm is set so that the rigidity differs between the pushing direction and the pulling direction of the inner cable, the set load in the compressing or drawing direction of the inner cable can be countervailed by a difference in rigidity of the elastic member between the pushing direction and the pulling direction, thereby eliminating deterioration in speed shift feeling.

Also, according to a second feature of the invention, there is provided a rigidity tuning structure of a transmission cable for a manual transmission in which a transmission cable for transmitting operation of a transmission lever by a driver to a manual transmission comprises an outer tube and an inner cable slidably accommodated within the outer tube, the inner cable being connected at one end to a select arm or a shift arm of the manual transmission, the outer tube being supported at one end on a casing of the manual transmission with an elastic member interposed therebetween, wherein rigidity of the elastic member differs between a pushing direction and a pulling direction of the outer tube.

A select cable 12 and a transmission cable 13 in a second embodiment disclosed herein correspond to the transmission cable of the present invention, and first and second rubber bushes 24 and 25 in the second embodiment correspond to the elastic member of the present invention.

With the above arrangement, even if a set load in a drawing direction or a compressing direction is applied to the inner cable due to the curvature of the transmission cable for transmitting the operation of the transmission lever to the select arm or the shift arm of the manual transmission, so that a set load in the drawing direction or the compressing direction is applied to the outer tube, because the rigidity of the elastic member connecting one end of the outer tube to the select arm or the shift arm is set so that the rigidity differs between the pushing direction and the pulling direction of the outer tube, the set load in the compressing or drawing direction applied to the outer tube can be countervailed by a difference in rigidity of the elastic member between the pushing direction and the pulling direction, thereby eliminating deterioration in speed shift feeling.

The above and other objects, features and advantages of the invention will become apparent from the following description of the present embodiments taken in conjunction with the accompanying drawings. It should be understood, however, that the detailed description of specific examples, while indicating the present embodiments of the invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIGS. 1 to 6 show a first embodiment of the present invention, wherein

FIG. 1 is a view showing ends of a select cable and a transmission cable on the side of a manual transmission;

FIG. 2 is an enlarged view of a section 2 in FIG. 1;

FIG. 3 is a sectional view taken along a line 3-3 in FIG. 1; FIG. 4 is a sectional view taken along a line 4-4 in FIG. 1; FIG. 5 is a sectional view taken along a line 5-5 in FIG. 4; and

FIG. 6 is a graph for explaining an effect of the present invention.

FIGS. 7 to 9 show a second embodiment of the present invention, wherein

FIG. 7 is a view corresponding to FIG. 2;

FIG. 8 is a view corresponding to FIG. 4; and

FIG. 9 is a view corresponding to FIG. 5.

FIG. 10 is a diagram for explaining a conventional problem in a case where a Bowden wire is bent.

FIG. 11 is a graph similar to FIG. 6, but relating to the prior art example.

### DESCRIPTION OF PRESENT EMBODIMENTS

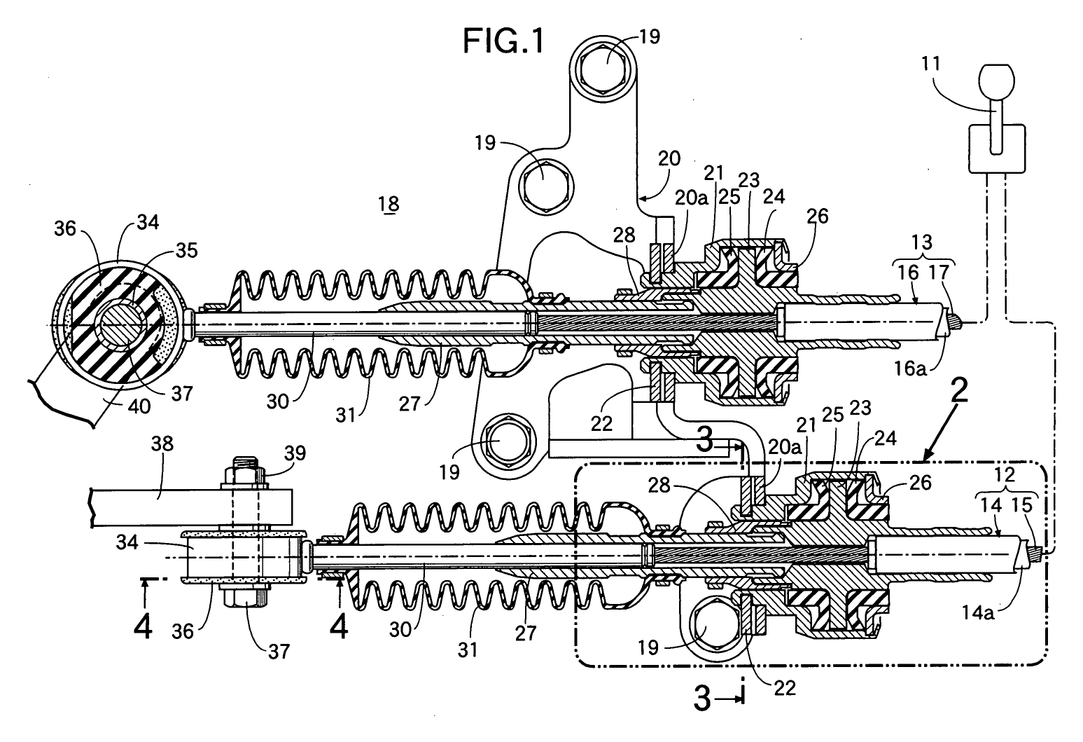

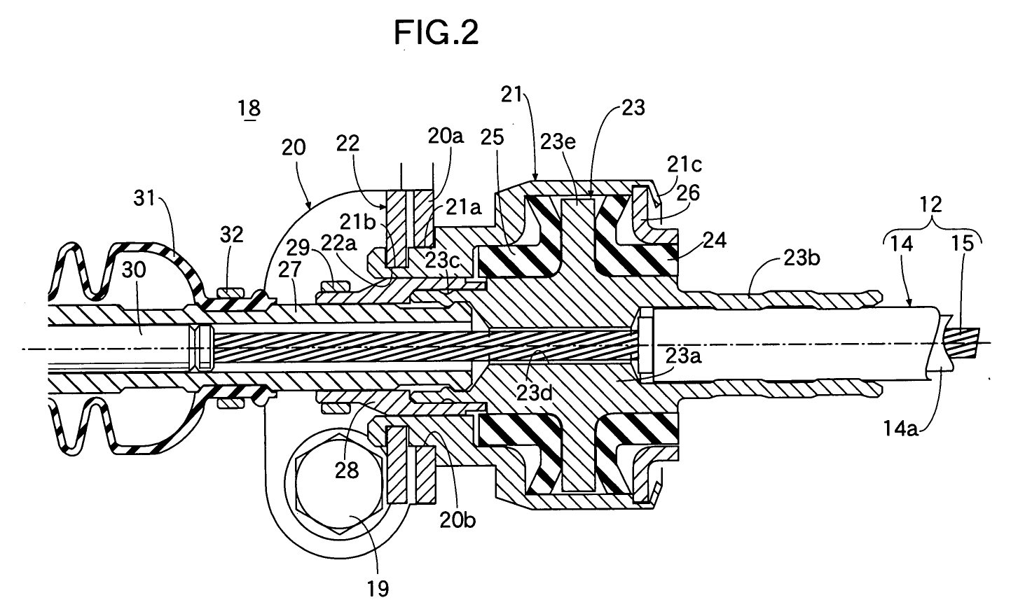

The first embodiment of the present invention will now be described with reference to FIGS. 1 to 6.

As shown in FIG. 1, the operation of a transmission lever 11 of an automobile provided with a manual transmission is transmitted to a shifting mechanism of the manual transmission through a select cable 12 and a transmission cable 13 each comprising a Bowden cable. The select cable 12 comprises an inner cable 15 made of stranded metal wires which is accommodated in an outer tube 14 having an inner peripheral surface coated with a liner 14a having a low friction coefficient. The transmission cable 13 comprises an inner cable 17 made of stranded metal wires which is accommodated in an outer tube 16 having an inner peripheral surface coated with a liner 16a having a low friction coefficient.

A bracket 20 is fixed to an outer surface of a casing 18 of the manual transmission by four bolts 19. The outer tube 14 of the select cable 12 and the outer tube 16 of the transmission cable 13 are supported at their ends on the bracket 20 in a floating manner. The structures of portions connecting the ends of the select cable 12 and the transmission cable 13 to the shifting mechanism of the manual transmission are substantially the same, and hence the structure of the select cable 12 will mainly be described as a representative.

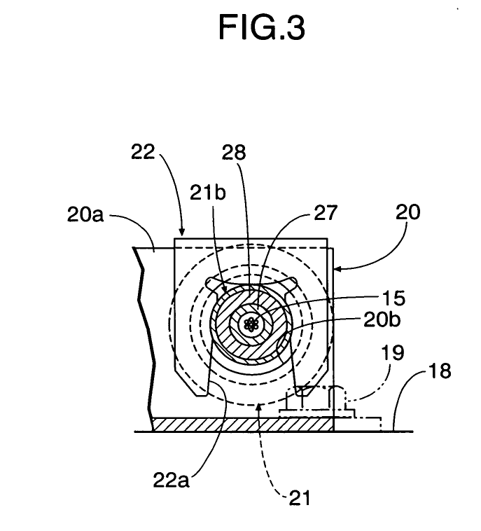

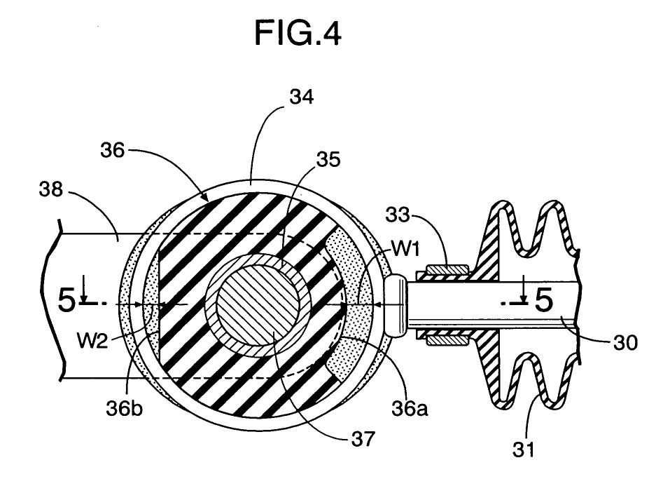

As can be seen by reference to FIGS. 2 and 3 in combination, a circular through-hole 20b is formed in a vertical wall 20a rising from the bracket 20, and a fitting portion 21a of a stepped cylindrical socket 21 is fitted into the through-hole 20b. In this state, a slip-off preventing plate 22 having a U-shaped notch 22a is engaged from above into an annular groove 21b formed in the socket 21, whereby the socket 21 is fixed to the vertical wall 20a of the bracket 20.

A case end 23 accommodated in the socket 21 includes a columnar body 23a, a first cylindrical portion 23b connected to a right end of the body 23a, a second cylindrical portion 23c connected to a left end of the body 23a, a guide bore 23d penetrating the body 23a to provide communication between the first and second cylindrical portions 23b and 23c, and a flange 23e formed around an outer periphery of the body 23a. An annular first rubber bush 24 and an annular second rubber bush 25 each having an L-shaped section are disposed on opposite side faces of the flange 23e of the case end 23. The first and second rubber bushes 24 and 25 are retained in the socket 21 by fixing a washer 26 covering a right side face of the second rubber bush 25 by a crimping portion 21c of the socket 21.

A left end of the outer tube 14 of the select cable 12 is fitted and fixed by crimping to an inner periphery of the first cylindrical portion 23b of the case end 23. As a result, the left end of the outer tube 14 of the select cable 12 is fixed to the casing 18 of the manual transmission through the case end 23, the first and second rubber bushes 24 and 25, the socket 21 and the bracket 20. At this time, the outer tube 14 is supported axially in a floating manner by the elastic deformation of the first and second rubber bushes 24 and 25, whereby the transmission of the vibration through the select cable 12 is inhibited.

A right end of a guide pipe 27 is fitted and fixed by caulking to an inner periphery of the second cylindrical portion 23c of the case end 23. A cylindrical wire seal 28 is fitted between outer peripheries of the second cylindrical portion 23c of the case end 23 and the guide pipe 27 and an inner periphery of the case end 23, and fixed to the outer periphery of the guide pipe 27 by a clip 29. A rod 30 is slidably supported within the guide pipe 27, and a portion of the inner cable 15 exposed from the outer tube 14 is passed through the guide bore 23d in the case end 23 and coupled to a right end of the rod 30. A boot 31 covering a left half of the guide pipe 27 and an exposed portion of the rod 30 is fixed at its opposite ends to the guide pipe 27 and the rod 30 by clips 32 and 33, respectively, clip 33 being shown in FIGS. 4, 5.

As can be seen from FIGS. 4 and 5, an outer shell 34 integrally provided at a left end of the rod 30 is fitted over an outer peripheral surface of the rubber bush 36, and an inner shell 35 disposed within the outer shell 34 is fixed by baking to an inner peripheral surface of the rubber bush 36. A pair of voids (spaces) 36a and 36b are formed between the outer shell 34 and the outer peripheral surface of the rubber bush 36. The void 36a on the side of the rod 30 has a radial width W1 larger than a radial width W2 of the void 36b opposite from the rod 30. A select arm 38 for selecting operation of the shifting mechanism of the manual transmission is swingably fitted at its tip end over a bolt 37 passed through the inner shell 35, and fixed by a nut 39 for prevention of slip-off.

An end of the transmission cable 13 is similarly connected to a shift arm 40 for shifting operation of the shifting mechanism of the manual transmission (see FIG. 1).

The operation of the first embodiment having the above-described arrangement will be described below.

When the transmission lever 11 is operated laterally, the select cable 12 is pushed or pulled, whereby the select arm 38 is moved to any of “a first-second gear shift position”, “a third-fourth gear shift position” and “a fifth-reverse gear shift position”. When the transmission lever 11 is operated longitudinally, the transmission cable 13 is pushed or pulled, whereby the shift arm 40 is moved to “a first gear shift position”, “a third gear shift position”, “a fifth gear shift position”, “a second gear shift position”, “a fourth gear shift position”, or “a reverse gear shift position”, whereby a desired gear shift stage is established in the manual transmission.

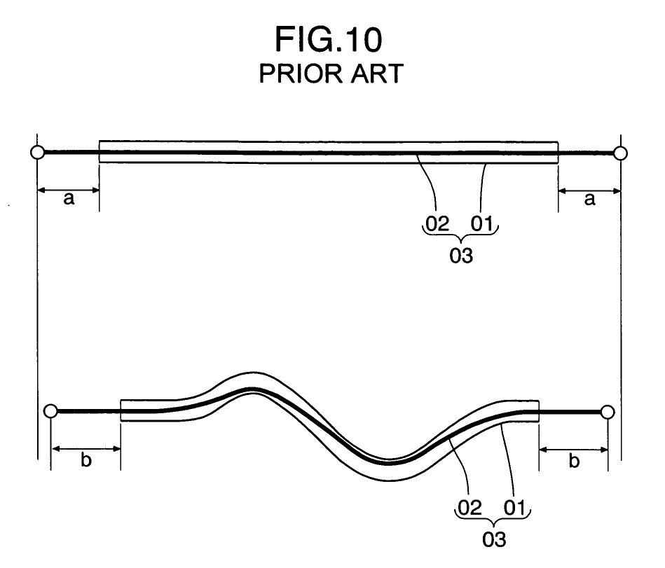

The following is a description taking the select cable 12 as an example. As already described in the section of “DESCRIPTION OF THE RELATED ART” using FIG. 10, if the select cable 12 is disposed so that it is curved between the transmission lever 11 and the manual transmission, the following problem is provided: a set load in a compressing direction is generated in the inner cable 15, and thus an operational feeling is hardened when operating the inner cable 15 in a pushing direction (namely, when further compressing the inner cable 15), while an operational feeling is softened when operating the inner cable 15 in a pulling direction (namely, when loosing the compression of the inner cable 15).

In the present embodiment, however, the imbalance of the operational feeling is moderated by ensuring that the rubber bush 36 disposed between the inner cable 15 and the select arm 38 is provided with an anisotropic property.

More specifically, when the inner cable 15 is pushed, the outer shell 34 connected to the rod 30 is moved in a direction shown by an arrow A in FIG. 5, whereby a portion B of the rubber bush 36 is compressed. However, the portion B has a lower rigidity because of the larger width W1 of the void 36a in the rubber bush 36, and can be easily compressed and deformed. Therefore, the hardened operational feeling upon pushing the inner cable 15 by virtue of the characteristic of the select cable 12 can be countervailed by a reduction in rigidity of the rubber bush 36, and corrected to be soft.

Conversely, when the inner cable 15 is pulled, the outer shell 34 connected to the rod 30 is moved in a direction shown by an arrow C in FIG. 5, whereby a portion D of the rubber bush 36 is compressed. However, the portion D has a higher rigidity because of the smaller width W2 of the void 36b in the rubber bush 36, and cannot be easily compressed or deformed. Therefore, the softened operational feeling upon pulling the inner cable 15 by virtue of the characteristic of the select cable 12 can be countervailed by an increase in rigidity of the rubber bush 36, and corrected to be hard.

As a result, a difference between loads generated upon pushing and pulling the inner cable 15 of the select cable 12 is decreased, thereby improving the operational feeling in the selecting operation of the transmission lever 11. Likewise, a difference between loads generated upon pushing and pulling the inner cable 17 of the transmission cable 13 is decreased due to a corresponding structural arrangement of the invention, thereby improving the operational feeling in the shifting operation of the transmission lever 11.

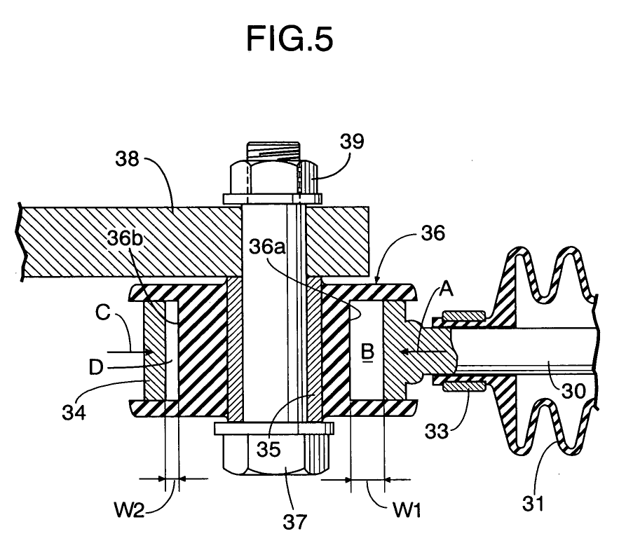

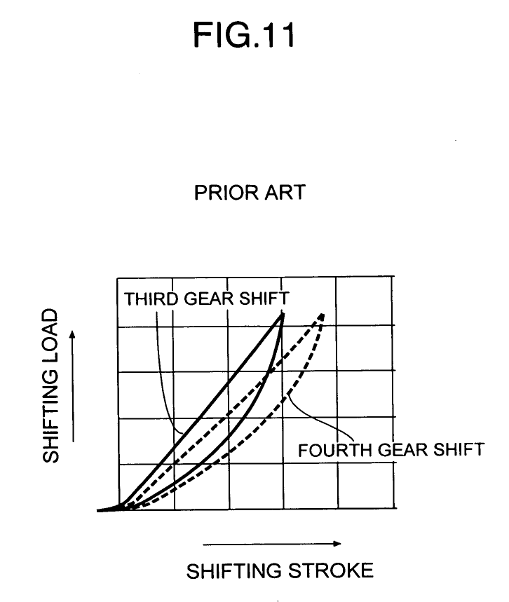

FIGS. 6 and 11 are graphs each showing the relationship between the shifting stroke and the shifting load in the shifting to a third gear shift stage and a fourth gear shift stage. FIG. 11 corresponds to the prior art in which the rubber bush 36 is provided with no anisotropic property, and FIG. 6 corresponds to the embodiment of the present invention in which the rubber bush 36 is provided with the anisotropic property. As apparent from these Figures, in the embodiment shown in FIG. 6, the difference between shifting loads required for the same shifting stroke in the shifting to the third gear shift stage and the fourth gear shift stage is small, as compared with the prior art shown in FIG. 11.

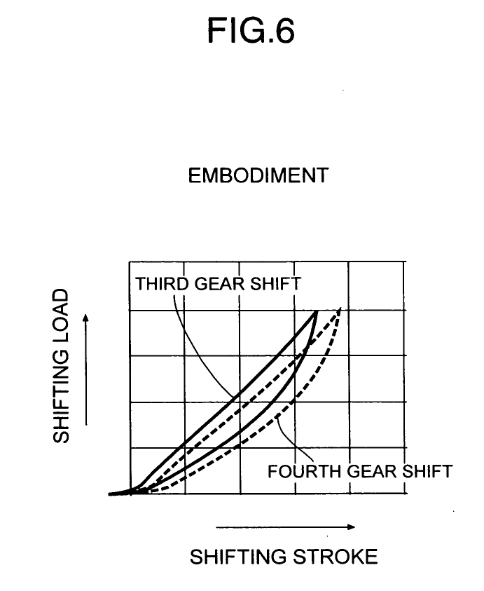

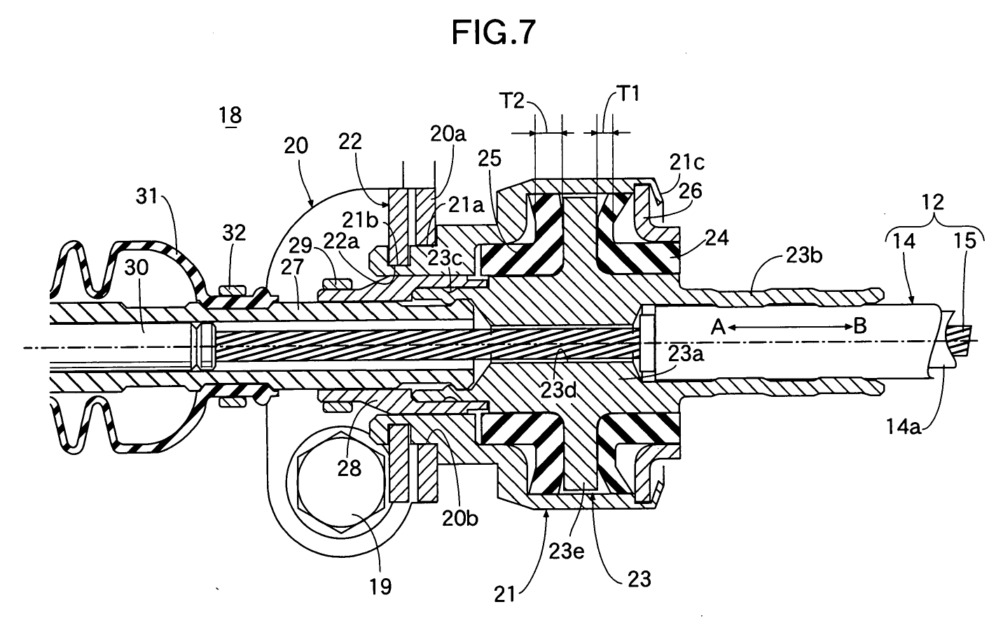

A second embodiment of the present invention will now be described with reference to FIGS. 7 to 9.

In the first embodiment, the first and second rubber bushes 24 and 25 have the same thickness, but in the second embodiment, as apparent from FIG. 7, a first rubber bush 24 has a thickness T1 smaller than a thickness T2 of a second bush 25. Therefore, when the outer tube 14 is pulled rightwards in FIG. 7, the thinner first rubber bush 24 is easily deformed to permit the rightward movement of the outer tube 14. Conversely, when the outer tube 14 is pushed leftwards in FIG. 7, the thicker second rubber bush 25 is difficult to deform, and hence the second rubber bush 25 resists the leftward movement of the outer tube 14. Namely, the total rigidity of the first and second rubber bushes 24 and 25 is lower in the direction of pulling the outer tube 14 and higher in the direction of compressing the outer tube 14.

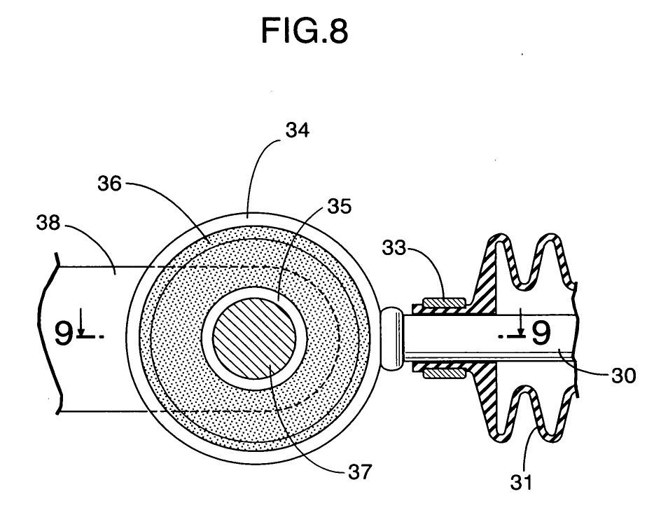

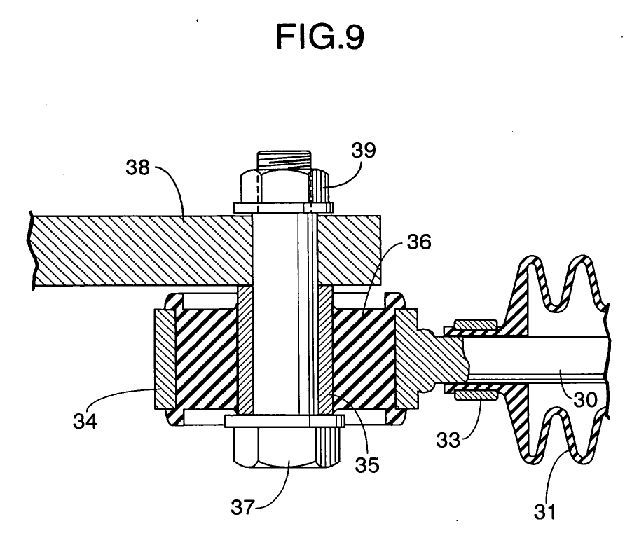

In addition, in the first embodiment, the pair of voids (spaces) 36a and 36b are formed between the outer shell 34 and the outer peripheral surface of the rubber bush 36, but in the second embodiment, no voids are formed between an outer shell 34 and an outer peripheral surface of a rubber bush 36, as apparent from FIGS. 8 and 9.

The arrangement of the other components in the second embodiment is the same as that in the first embodiment.

The operation of the second embodiment having the above-described arrangement will be described below.

When the transmission lever 11 is operated laterally, the select cable 12 is pushed or pulled, whereby the select arm 38 is moved to any of “a first-second gear shift position”, “a third-fourth gear shift position” and “a fifth-reverse gear shift position”. When the transmission lever 11 is operated longitudinally, the transmission cable 13 is pushed or pulled, whereby the shift arm 40 is moved to “a first gear shift position”, “a third gear shift position”, “a fifth gear shift position”, “a second gear shift position”, “a fourth gear shift position”, or “a reverse gear shift position”, whereby a desired gear shift stage is established in the manual transmission.

The following is a description taking the select cable 12 as a representative. As already described in the section of “DESCRIPTION OF THE RELATED ART” using FIG. 10, if the select cable 12 is disposed so that it is curved between the transmission lever 11 and the manual transmission, the following problem is provided: a set load in a compressing direction is generated in the inner cable 15, and a resulting reaction force generates a set load in a pulling direction in the outer tube 14, and thus, an operational feeling is hardened when operating the inner cable 15 in a pushing direction (namely, when further compressing the inner cable 15, while stretching the outer tube 14), and on the other hand, an operational feeling is softened when operating the inner cable 15 in a pulling direction (namely, when loosening the compression of the inner cable 15, while loosening the pulling of the outer tube 14).

In the second embodiment, however, the imbalance of the operational feeling is moderated by ensuring that each of the first and second rubber bushes 24 and 25 for supporting the end of the outer tube 14 in the socket 21 is provided with an anisotropic property.

More specifically, when the inner cable 15 is pushed in a direction shown by an arrow A in FIG. 7, a resulting reaction force causes the outer tube 14 to be pulled in a direction shown by an arrow B. However, when the outer tube 14 is moved in the direction shown by the arrow B, the flange 23e of the case end 23 pushes the thinner first rubber bush 24 to deform it to a relatively large extent, whereby the movement of the outer tube 14 can be permitted in the direction shown by the arrow B to decrease the rigidity when compressing the inner cable 15 in the direction shown by the arrow A. Therefore, the hardened operational feeling upon pushing the inner cable 15 by virtue of the characteristic of the select cable 12 can be countervailed by the lower rigidity of the first rubber bush 24, and corrected to be soft.

Conversely, when the inner cable 15 is pulled in the direction of the arrow B in FIG. 7, a resulting reaction force causes the outer tube 14 to be pushed in the direction of the arrow A. However, when the outer tube 14 is moved in the direction of the arrow A, the flange 23e of the case end 23 pushes the thicker second rubber bush 25 to deform it to a relatively small extent, whereby the movement of the outer tube 14 in the direction of the arrow A can be inhibited to increase the rigidity in pulling the inner cable 15 in the direction of the arrow B. Therefore, the softened operational feeling upon pulling the inner cable 15 by virtue of the characteristic of the select cable 12 can be countervailed by the high rigidity of the second rubber bush 25, and corrected to be hard.

As a result, a difference between loads generated upon pushing and pulling the inner cable 15 of the select cable 12 is decreased, thereby improving the operational feeling in the selecting operation of the transmission lever 11. Likewise, a difference between loads generated upon pushing and pulling the inner cable 17 of the transmission cable 13 is decreased due to a corresponding structural arrangement of the present invention, thereby improving the operational feeling in the shifting operation of the transmission lever 11.

Thus, according also to the second embodiment, an operational effect same as that in the first embodiment can be achieved.

Although the embodiments of the present invention have been described, various modifications in design may be made without departing from the subject matter of the invention.

For example, in the first embodiment, the rigidity of the rubber bush 36 is set so that it is lower in the pushing direction than in the pulling direction, but when a set load in the pulling direction is generated in the inner cable 15, 17 depending on how the select cable 12 and the transmission cable 13 are disposed, the rigidity of the rubber bush 36 may be set so that it is higher in the pushing direction than in the pulling direction.

In addition, in the first embodiment, the anisotropic property is given to the rubber bush 36 by changing the radial widths W1 and W2 of the voids 36a and 36b of the rubber bush 36 in the circumferential direction, but the anisotropic property can be given to the rubber bush 36 by forming the rubber bush 36 in two colors from rubbers different in hardness or by any other means.

In the second embodiment, the rigidity of each of the first and second rubber bushes 24 and 25 is set so that it is lower in the direction of pulling the outer tubes 14 and 16 than in the direction of pushing the outer tubes 14 and 16, but when a set load in the compressing direction is generated in the outer tube 14, 16 depending on how the select cable 12 and the transmission cable 13 are disposed, the rigidity of each of the first and second rubber bushes 24 and 25 may be set so that it is higher in the pulling direction than in the pushing direction.

In addition, in the second embodiment, the anisotropic property is given to the first and second rubber bushes 24 and 25 by changing the thicknesses of the first and second rubber bushes 24 and 25, but can be given to the first and second rubber bushes 24 and 25 by forming voids (spaces) in the first and second rubber bushes 24 and 25, or by using rubbers having different hardness, or by any other means.

Further, in the embodiments, the present invention is applied to both the select cable 12 and the transmission cable 13, but may be applied to only one of the select cable 12 and the transmission cable 13.

What is claimed is:

1. A rigidity tuning structure of a transmission cable for a manual transmission in which a transmission cable for transmitting operation of a transmission lever by a driver to a manual transmission comprises an outer tube and an inner cable slidably accommodated within the outer tube, the outer tube being fixed at one end to a casing of the manual transmission, and the inner cable being connected at one end to a select arm or a shift arm of the manual transmission through an elastic member,
wherein rigidity of the elastic member differs between a pushing direction and a pulling direction of the inner cable.

2. The rigidity tuning structure according to claim 1, wherein the elastic member has a pair of voids associated with surfaces on opposite sides thereof such that the rigidity of the elastic member differs between the pushing direction and the pulling direction of the inner cable.

3. The rigidity tuning structure according to claim 2, wherein the voids have different widths.

4. The rigidity tuning structure according to claim 2, wherein the elastic member is disposed within a shell, and the voids are formed between the elastic member and the shell.

5. A rigidity tuning structure of a transmission cable for a manual transmission in which a transmission cable for transmitting operation of a transmission lever by a driver to a manual transmission comprises an outer tube and an inner cable slidably accommodated within the outer tube, the inner cable being connected at one end to a select arm or a shift arm of the manual transmission, and the outer tube being supported at one end on a casing of the manual transmission with an elastic member interposed therebetween,
wherein rigidity of the elastic member differs between a pushing direction and a pulling direction of the outer tube.

6. The rigidity tuning structure according to claim 5, wherein the elastic member comprises a pair of bushes, one of the bushes is compressed between the transmission casing and the outer tube in the pushing direction of the outer tube, and other bush is compressed between the transmission casing and the outer tube in the pulling direction of the outer tube, and the bushes have different rigidities.

7. The rigidity tuning structure according to claim 6, wherein the bushes have different thicknesses giving the different rigidities.

8. A rigidity tuning structure of a transmission cable for a manual transmission in which a transmission cable for transmitting operation of a transmission lever by a driver to a manual transmission comprises an outer tube and an inner cable slidably accommodated within the outer tube, the outer tube being fixed at one end to a casing of the manual transmission with a first elastic member interposed therebetween, and the inner cable being connected at one end to a select arm or a shift arm of the manual transmission through a second elastic member,
wherein rigidity of at least one of the elastic members differs between a pushing direction and a pulling direction of the inner cable.

9. The rigidity tuning structure according to claim 8, wherein the second elastic member has a pair of voids associated with surfaces on opposite sides thereof such that the rigidity of the elastic member differs between the pushing direction and the pulling direction of the inner cable.

10. The rigidity tuning structure according to claim 9, wherein the voids have different widths.

11. The rigidity tuning structure according to claim 9, wherein the second elastic member is disposed within a shell, and the voids are formed between the elastic member and the shell.

12. The rigidity tuning structure according to claim 8, wherein the first elastic member comprises a pair of bushes, one of the bushes is compressed between the transmission casing and the outer tube in the pushing direction of the outer tube, and other bush is compressed between the transmission casing and the outer tube in the pulling direction of the outer tube, and the bushes have different rigidities.

13. The rigidity tuning structure according to claim 12, wherein the bushes have different thicknesses giving the different rigidities.
